(19) United States
(12) Patent Application Publication
(10) Pub. No.: US 2025/0075076 A1
(43) Pub. Date: Mar. 6, 2025

(54) Self-Healing Thermoplastic Elastomer Composition

(71) Applicant: Becton, Dickinson and Company, Franklin Lakes, NJ (US)

(72) Inventors: Wen Yuan, Mountain Lakes, NJ (US); Xianhong Feng, Kearny, NJ (US)

(21) Appl. No.: 18/292,030

(22) PCT Filed: Jul. 29, 2022
(86) PCT No.: PCT/US2022/038899

§ 371 Date: Jan. 25, 2024

Related U.S. Application Data
(60) Provisional application No. 63/227,585, filed on Jul. 30, 2021.

(51) Int. Cl. C08L 91/00; A61J 1/14

(52) U.S. Cl. CPC C08L 91/00; A61J 1/1406; C08L 2207/04

(57) ABSTRACT

A self-healing membrane includes a material having a molecular weight greater than 35 k Da, at least 50% by weight of mineral oil, at least 40% styrenic block copolymer, and 0-10% polypropylene. The membrane may be utilized in any component of a closed system transfer device or system, such as a syringe adapter, patient connector, vial adapter, IV bag spike, etc. The membrane may also be utilized in other medical device components and, more specifically, medical device components where the membrane is punctured by a needle.

### CROSS-REFERENCE TO RELATED APPLICATION

The present application claims priority to U.S. Provisional Application Ser. No. 63/227,585, filed Jul. 30, 2021, the entire disclosure of which is hereby incorporated by reference in its entirety.

### BACKGROUND OF THE INVENTION

### Field of the Disclosure

The present disclosure relates generally to a self-healing thermoplastic elastomer composition.

### Description of the Related Art

Health care providers reconstituting, transporting, and administering hazardous drugs, such as cancer treatments, can put health care providers at risk of exposure to these medications and present a hazard in the health care environment. Unintentional chemotherapy exposure can affect the nervous system, impair the reproductive system, and bring an increased risk of developing blood cancers in the future. Some drugs must be dissolved or diluted before they are administered, which involves transferring a solvent from one container to a sealed vial containing the drug in powder or liquid form, by means of a needle. Drugs may be inadvertently released into the atmosphere in gas form or by way of acrosolization, during the withdrawal of the needle from the vial and while the needle is inside the vial, if any pressure differential between the interior of the vial and the surrounding atmosphere exists. In order to reduce the risk of health care providers being exposed to toxic drugs, the transfer of these drugs is accomplished utilizing a closed system transfer device or system.

Closed system transfer devices or systems may utilize membranes to ensure the safe transfer of fluid between components. For example, a syringe adapter may include a membrane that contacts a membrane of a mating component, such as a patient connector, IV bag spike, or vial adapter. The membrane, which may be formed from a thermosetting isoprene rubber, is pierced by a needle of the syringe adapter. Accordingly, the membrane is required to meet scaling and leakage requirements while also limiting membrane fragmentation, which can create small material particles when the needle pierces through the membrane that can pose a risk to a patient. A lubricating agent, such as silicone oil, can be applied to the needle surface and the membrane to minimize membrane fragmentation. The use of a lubricating agent on the surface of the needle and membrane, however, can affect leakage performance, fragmentation, and flow rate through the syringe adapter.

### BRIEF DESCRIPTION OF THE DRAWINGS

The above-mentioned and other features and advantages of this disclosure, and the manner of attaining them, will become more apparent and the disclosure itself will be better understood by reference to the following descriptions of aspects of the disclosure taken in conjunction with the accompanying drawings, wherein:

FIG. 1 is a front view of a patient connector according to one aspect or embodiment of the present application;

FIG. 2 is a cross-sectional view of the patient connector of FIG. 1;

FIG. 3 is a cross-sectional view of the patient connector of FIG. 1, showing the patient connector being inserted into a syringe adapter;

FIG. 4 is a cross-sectional view of the patient connector of FIG. 1, showing the patient connector inserted into a syringe adapter; and

FIG. 5 is an illustration of styrene-ethylenebutylene-styrene structure correlated to thermoplastic elastomer elasticity and processing.

Corresponding reference characters indicate corresponding parts throughout the several views. The exemplifications set out herein illustrate exemplary aspects of the disclosure, and such exemplifications are not to be construed as limiting the scope of the disclosure in any manner.

### DETAILED DESCRIPTION

The following description is provided to enable those skilled in the art to make and use the described aspects contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”. “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary aspects of the invention. Hence, specific dimensions and other physical characteristics related to the aspects disclosed herein are not to be considered as limiting.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less.

The terms “first”, “second”, and the like are not intended to refer to any particular order or chronology, but refer to different conditions, properties, or elements.

As used herein, “at least one of” is synonymous with “one or more of”. For example, the phrase “at least one of A, B, and C” means any one of A, B, or C, or any combination of any two or more of A, B, or C. For example, “at least one of A, B, and C” includes one or more of A alone; or one or more of B alone; or one or more of C alone; or one or more of A and one or more of B; or one or more of A and one or more of C; or one or more of B and one or more of C; or one or more of all of A, B, and C.

In one aspect or embodiment of the present application, a self-healing membrane 10 includes a material having a molecular weight greater than 35 k Da, at least 50% by weight of mineral oil, at least 40% styrenic block copolymer, and 0-10% polypropylene. The membrane 10 may be utilized in any component of a closed system transfer device or system, such as a syringe adapter, patient connector, vial adapter, IV bag spike, etc. The membrane 10 may be utilized with the syringe adapter shown and described in United States Patent Application Publication No. 2015/0297454, which is hereby incorporated by reference in its entirety. The membrane 10 may also be utilized in other medical device components and, more specifically, medical device components where the membrane 10 is punctured by a needle.

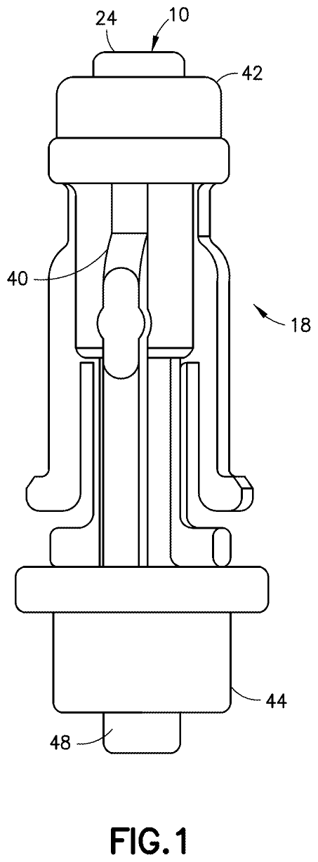

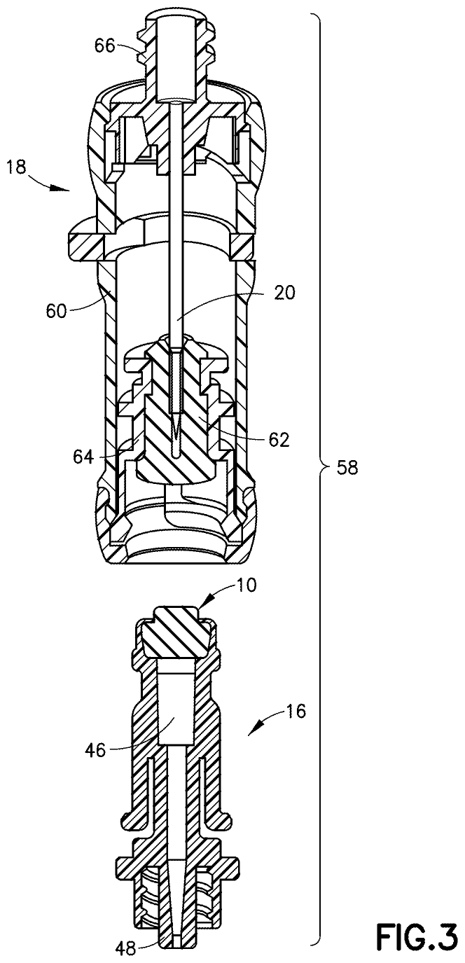

Referring to FIGS. 1-4, the membrane 10 is shown in connection with a patient connector 16, which is utilized to connect one component of a closed system transfer device or system to a patient intravenous line. For example, the patient connector 16 may be connected to a syringe adapter 18 to facilitate the transfer of fluid from one container, such as a syringe barrel, to another container or line, such as an intravenous line, IV bag, or other component. The membrane 10 is configured to prevent leakage through the membrane 10 when the membrane 10 is punctured by a cannula 20. During use, the cannula 20 of the syringe adapter 18 may puncture the membrane 10 and quickly, such as a time period of 10 seconds or shorter, be withdrawn from the membrane. The membrane 10 may also be utilized in scenarios where the cannula 20 of the syringe adapter 18 punctures the membrane 10 and remains in the punctured position for an extended period of time, such as one hour or greater. The membrane 10 is configured to prevent leakage through the membrane 10, such as through an opening caused by the cannula 20 puncturing the membrane 10 or through an interface between the cannula 20 and the membrane 10. A top surface 24 of the membrane 10 is configured to engage a counterpart membrane of another component, as discussed below. The membrane 10 may include a flange 28 as well as other features and structures.

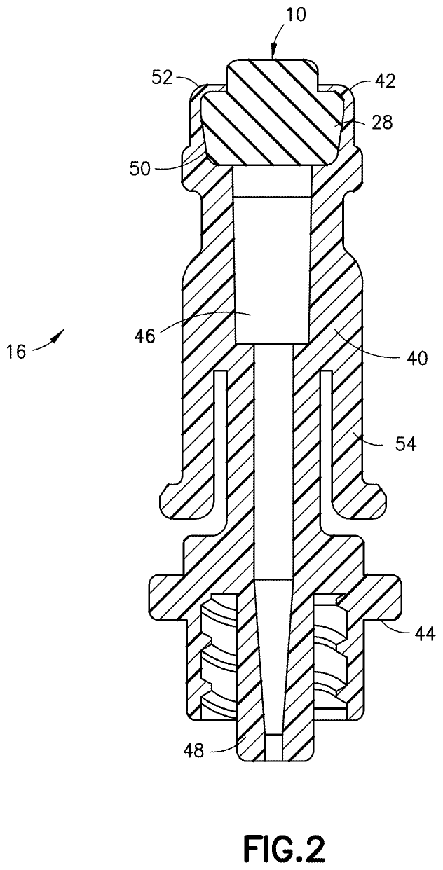

Referring again to FIGS. 1 and 2, the patient connector 16 includes a body 40 having a first end 42 and a second end 44, with the body 40 defining a passageway 46, a line connection 48 positioned at the second end 44 of the body 40, and the membrane 10 positioned at the first end 42 of the body 40. The line connection 48 may be a luer lock connection, although other suitable connections may be utilized. The membrane 10 is received by an opening 50 defined by the body 40 of the patient connector 16. The opening 50 of the patient connector 16 is wider than the passageway 46. The body 40 of the patient connector 16 includes a securing extension 52 at the first end 42 of the body 40, with the securing extension 52 extending radially inward and configured to secure the membrane 10 to the body 40 of the patient connector 16. The patient connector 16 also includes a locking arrangement 54 configured to secure the patient connector 16 to the syringe adapter 18.

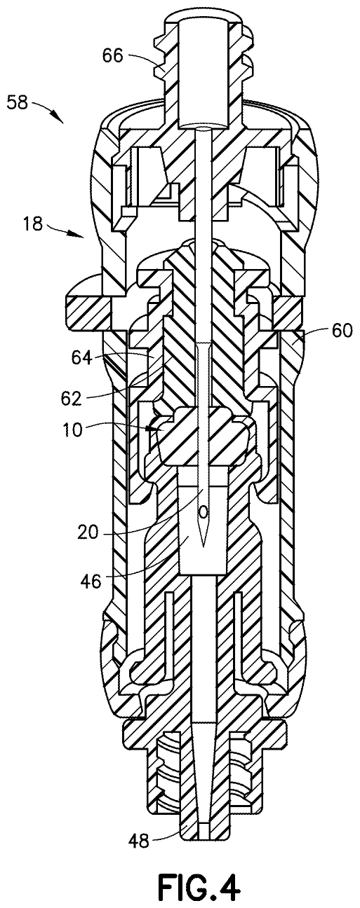

In a further aspect or embodiment, a system 58 for the closed transfer of fluid includes the patient connector 16 and the syringe adapter 18, although the system 58 may also include other components of a closed system transfer device or system. The syringe adapter 18 includes a housing 60 having a syringe adapter membrane 62 received within the housing 60 and the cannula 20. The syringe adapter membrane 62 is moveable from a first position within the housing 60 of the syringe adapter 18 to a second position within the housing 60 when the patient connector 16 is positioned within the housing 60 of the syringe adapter 18, as shown in FIG. 4. The membrane 10 of the patient connector 16 is configured to engage the syringe adapter membrane 62. The cannula 20 is configured to puncture the membrane 10 of the patient connector 16 and the syringe adapter member 62 when the patient connector 16 is positioned within the housing 60 of the syringe adapter 18. The syringe adapter membrane 62 is received by a collet 64, although other suitable arrangements may be utilized. The syringe adapter 18 includes a luer connector 66 configured to be secured to a syringe barrel. The operation of the syringe adapter 18 is described in United States Patent Application Publication No. 2015/0297454. Accordingly, the membrane 10 and the syringe adapter member 62 needs to maintain a seal to form a closed system while also minimizing fragmentation of the material during puncturing of the membranes 10, 62 with the cannula 20.

Thermoplastic elastomer (TPE) provides similar properties to conventional rubber materials such as thermoset rubber and silicone rubber. TPE is crosslinked by polymer chain physical interaction, not via covalent bonding, thus it is recyclable and easier to process compared to thermoset rubber and silicone. Extruded and molded TPE articles are widely used as crucial components in medical device applications, such as septum, stopper, rescalable membrane and tubing, which generally require high elasticity, flexibility and great stability.

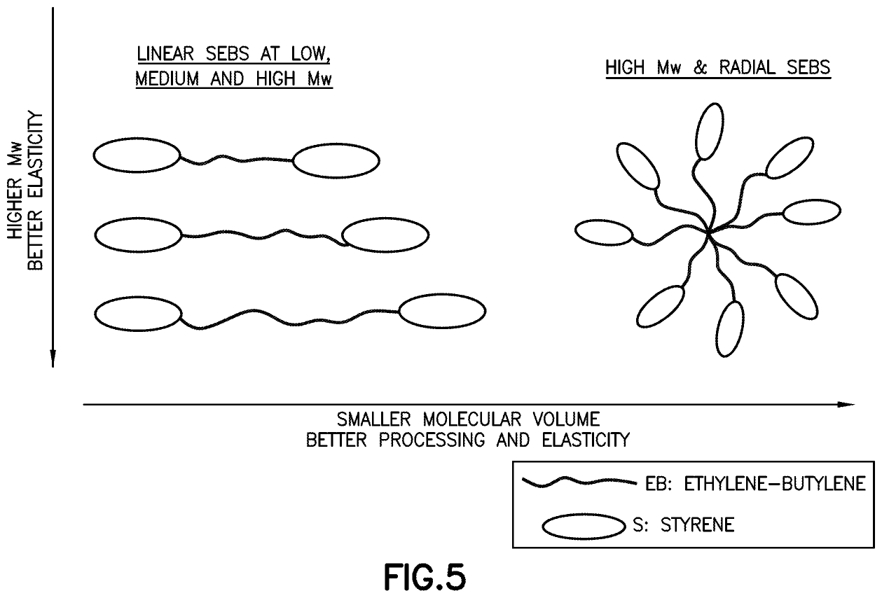

The elasticity of TPE results from styrenic block copolymers (SBCs), which formed a phase separation between the glassy and rubbery domains. Examples of SBCs include SBS block copolymers (styrene-butadiene-styrene), SIS block copolymers (styrene-isoprene-styrene), and SI/BS block copolymers (styrene-isoprene/butadiene-styrene), and the hydrogenated SBC such as SEBS (styrene-ethylenebutylene-styrene), SEPS (styrene-ethylene/propylene-3-methylbutene-styrene), SEEPS (styrene-ethylene-ethylene/propylene-styrene), and SIPS (styrene-isoprene-styrene block copolymer). A general TPE is formulated by blending SBC, polyolefins such as PP and PE, plasticizers, fillers, stabilizers and other additives. To get a satisfied elasticity for different TPE applications, both molecular weight and SBC structure will impact the resulted TPE's elasticity or resilience. In general, a higher molecular weight (Mw) SBC will offer a better elasticity because of a longer and tighter polymer chain entanglement. However, a longer SBC chain with a higher Mw (Mw>35 k Da) will likely need processed in a much higher temperature/shear extrusion condition or need sufficient time to reach a melted state for extrusion, thus the proper selection of the right SBC with the right Mw is critical to balance TPE's elasticity and manufacturability. In general, there are two types of SBCs including linear and radial structure. Most commercial grades of SBCs are produced to the linear structure through conventional anionic living polymerization, which offer a great performance in elastomer application. A radial structure of SBCs demonstrates a smaller molecular volume and similar Mw range, which allows the melting process to be easier and leads to a more homogeneous TPE formulation after compounding. As illustrated in FIG. 5, the resulted TPE with radial SEBS will also provide a great elasticity while exhibiting excellent processability.

Unlike isoprene rubber, TPE properties can be optimized through formulation and compounding while also providing benefits such as better recyclability and manufacturing efficiency. In addition, the benefits of switching to TPE from isoprene rubber mean there will be fewer product requirement tradeoffs, as TPE is more easily tunable in composition for desired material properties. According to one aspect or embodiment of the present application, a material composition including a blend of a radial structure SEBS, a PP copolymer and a mineral oil with a self-sealing capability to boost the leakage performance of needle penetrable elastomer articles is provided. The TPE material of the present application has met the desired hardness and with a room temperature compression set less than about 10%. A molded article produced from such a TPE formulation is resealable and proved excellent leakage and fragmentation performance in needle penetrable elastomer articles including closed system transfer device products. Although discussed in connection with the membrane 10, the materials discussed below may be utilized for the syringe adapter member 62 or any other membrane utilized in a closed system transfer device.

All the TPE formulations were compounded on a Thermo Fisher 16 mm twin screw extruder with a customized strand die. The extruded polymer strand was cooled in the water bath and then cut into pellets. A DOE mixture was designed with four different grades of SEBS, which included three linear structure SEBS in low, medium and high molecular weight and one radial structure SEBS in high molecular weight. In Table 1, eight formulations were created, each with 100 phr SEBS, and varying phr of the PP and oil. Both an antioxidant and slip agent were also added in all eight formulations for material stability and processability purposes. The hardness was well controlled in the range from 25 Shore A to 35 Shore A, which is suitable, for example, for closed system transfer device applications. The compression set at 22 hrs and 96 hrs were also tested. It is shown that COE-TPE 25, 27 and 28 perform the best on a compression set which indicated greater elastic properties provided by high molecular weight SEBS. All three TPEs were compress molded to the sheets for the additional material characterization along with three off-the-shelf TPE references shown in Table 2.

TABLE 1
Summary of internal formulated TPE.

| | | COE- | COE- | COE- | COE- | COE- | COE- | COE- | COE- |
|---|---|---|---|---|---|---|---|---|---|
| | | TPE-21 | TPE-22 | TPE-23 | TPE-24 | TPE-25 | TPE-26 | TPE-27 | TPE-28 |
| SEBS | Kraton G1654 | 100 | 100 | | | | | | |
| | Kraton G1651 | | | 100 | 100 | | | | |
| | Kraton G1633 | | | | | 100 | 100 | | |
| | Dynasol | | | | | | | 100 | 100 |
| | C-H6410XP | | | | | | | | |
| PP | Exxon PP9122 | 15 | 25 | 15 | 25 | 15 | 25 | 15 | 25 |
| Mineral Oil | Penreco | 115 | 125 | 115 | 125 | 115 | 125 | 115 | 125 |
| | Drakeol 34 | | | | | | | | |
| Antioxidant | BASF Irganox ® | 1 | 1 | 1 | 1 | 1 | 1 | 1 | 1 |
| | 1010 | | | | | | | | |
| Slip Agent | Croda | 1 | 1 | 1 | 1 | 1 | 1 | 1 | 1 |
| | Crodamide ™ ER | | | | | | | | |

| | | | | | | | | |
|---|---|---|---|---|---|---|---|---|
| Compression set 23 C./22 hrs | 12.7 | 9.1 | 18 | 17 | 11.4 | 11.4 | 7.2 | 7.3 |
| Compression set 23 C./96 hrs | 18.1 | 16.8 | 19.7 | 18.9 | 15.6 | 20.2 | 10.6 | 13.8 |
| Shore A Hardness | 28.5 | 35 | 16 | 28.5 | 25.5 | 32.5 | 27 | 31.5 |

In Table 2, it is shown that COE-TPE 25, 27 and 28 have superior elasticity property results from both compression set and DMA tan delta testing compared to reference TPEs, which generally correlate to the resealability in molded TPE parts after a long period or multi-pierces by a needle. A simple and quick test was designed to evaluate the TPE long term resealability in a disc form. A disc was punched out from the molded TPE sheet and then crimped on a vial containing a dye solution. The needle was used to penetrate the TPE disc 9 times in the same spot. For the tenth penetration, the needle was left in the disc for 96 hours. After the needle was withdrawn, the vial was flipped and placed on a white piece of paper for a few minutes to check for leaks from the punctured hole. A penetration score was determined by measuring the dab area on the piece of paper. with the lowest value being the best performance. COE-TPE 25, 27 and 28 had no leakage after the 96-hour penetration testing. It is clearly shown that both linear and radial structure of high Mw SEBS (Mw>35 k Da) provide the resulted TPE better compression set and DMA tan delta and penetration performance compared to reference TPEs which is likely made of low or medium Mw linear structure SEBS.

In addition, COE-TPE 25, 27 and 28 have also demonstrated a much lower tackiness level against reference TPEs from a separation force testing between two identical TPE molded parts, which provided a benefit for the manufacturing assembly process. All six TPEs performed a comparable and acceptable tensile strength, elongation at break and tear strength.

TABLE 2
Summary of material properties of 3 internal formulated
TPE plus 3 off-the-shelf TPEs as references.

| | Ref | Ref | Ref | COE- | COE- | COE- |
|---|---|---|---|---|---|---|
| | TPE-1 | TPE-2 | TPE-3 | TPE-25 | TPE-27 | TPE-28 |
| Oil % | 63 | 63 | 40 | 50 | 50 | 50 |
| Tensile at break/Mpa | 3.8 | 4.86 | 8.76 | 3 | 4.8 | 3 |
| Elongation at break/% | 853% | 750% | 720% | 1060% | 1100% | 751% |
| Hardness, Shore A | 25 | 31 | 38 | 26 | 27 | 32 |
| Tear resistance kN/m | 9.8 | 19.3 | 26.3 | 12.5 | 15.8 | 16.2 |
| Separation force/N | 0.39 | 0.34 | 0.24 | 0.012 | 0.141 | 0.008 |
| Compression set 22 hr 23 C./% | 13.00 | 17.00% | 12.00 | 11.40% | 7.20% | 7.80% |
| Compression set 96 hr 23 C./% | 19.3% | 18.1% | 17.2% | 15.6% | 10.6% | 13.8% |
| DMA-25C/1 Hz Tan delta | 0.079 | 0.081 | 0.062 | 0.057 | 0.059 | 0.063 |
| Penetration score-96 hrs | 0 | 6 | 8 | 0 | 0 | 0 |

All six TPEs including three references and three in-house formulated TPEs have been molded into parts and assembled to the closed system transfer device for product evaluation on short term leakage, long term leakage, fragmentation and attachment force. As shown in Table 3, when the proper SBC (Mw>35 k Da) with both linear and radial structure is used in the right composition (>40% SEBS), the sealing articles' short term leakage as well as long term leakage will improve significantly without compromising their fragmentation and attachment performance.

TABLE 3
Summary of product testing of 3 internal formulated
TPE plus 3 off-the-shelf TPEs as references.

| | Ref | Ref | Ref | COE- | COE- | COE- |
|---|---|---|---|---|---|---|
| | TPE- | TPE- | TPE- | TPE- | TPE- | TPE- |
| | 1 | 2 | 3 | 25 | 27 | 28 |
| Short Term | 1.11 | 1.11 | 0.66 | 0.36 | 0.42 | 0.42 |
| Leakage/mm²(Lower | | | | | | |
| is better) | | | | | | |
| Long term Leakage | 1 | 1.9 | 1 | 1 | 1 | 1 |
| score-Injector-72 hrs | | | | | | |
| (Lower is better) | | | | | | |
| Long term Leakage | 2.27 | 3.97 | 2.97 | 1.83 | 1.1 | 1.27 |
| score-Connetor-72 hrs | | | | | | |
| (Lower is better) | | | | | | |
| Long term Leakage | 1.2 | 2 | 1 | 1.23 | 1 | 1.13 |
| score-Injector-96 hrs | | | | | | |
| (Lower is better) | | | | | | |
| Long term Leakage | 2.27 | 3.9 | 3.53 | 2.43 | 1.2 | 1.5 |
| score-Connetor-96 hrs | | | | | | |
| (Lower is better) | | | | | | |
| Fragmentation score | Pass | Pass | Pass | Pass | Pass | Pass |
| Attachment | Pass | Fail | Fail | Pass | Pass | Pass |

*Long term leakage score is range from 1 to 4, the lower the better.

A self-healing thermoplastic elastomer according to one aspect or embodiment of the present application provides the following properties: 1) significantly improved resealing property of needle penetrable elastomer article after long compression with its unique SEBS polymer structure (high Mw linear or radial, >35 k Da) and its corresponding composition including 50% oil, >40% SBC and <10% PP; 2) provides a well-balanced mechanical property including hardness (Shore A 29+5), tensile (>3 Mpa), tear (>12 kNm), 96 hr compression set (<16%), tan delta (<0.065) to meet all the requirements including leakage and fragmentation for closed system transfer device applications and potentially can be tweaked to other hardness for other needle penetrable sealing applications, e.g., catheter septum, connector, etc.; 3) eliminates silicone oil usage on the needle surface as well as sealing component surface to prevent drug interactions with silicone oil and potentially increase the flow rate of drug delivery system without compromising fragmentation performance of needle penetrable septum thus improve safety and efficacy of drug delivery devices.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims. To the extent possible, one or more features of any aspect or embodiment discussed above can be combined with one or more features of any other aspect or embodiment.

1. A self-healing membrane comprising:
a material comprising a molecular weight greater than 35 k Da, at least 50% by weight of mineral oil, at least 40% styrenic block copolymer, and 0-10% polypropylene.

2. The membrane of claim 1, wherein the material includes at least one of radial and liner structures.

3. The membrane of claim 1, wherein the material has a Shore A hardness of 24-34.

4. The membrane of claim 1, wherein the material has a tensile strength greater than 3 Mpa.

5. The membrane of claim 1, wherein the material has a tear resistance of greater than 12 kNm.

6. The membrane of claim 1, wherein the material has a 96 hour compression set of less than 16%.

7. The membrane of claim 1, wherein the material has a tan delta of less than 0.065.

8. The membrane of claim 1, wherein an outer surface of the material is free from silicone oil.
